(19) United States
(12) Patent Application Publication
(10) Pub. No.: US 2011/0055744 A1
(43) Pub. Date: Mar. 3, 2011

(54) Visual Linking of Elements to Model Attributes

(76) Inventors: Christopher N. Ryan, Windham, NH (US); Daniel E. Gobera Rubalcava, Cupertino, CA (US)

(21) Appl. No.: 12/550,283

(22) Filed: Aug. 28, 2009

(51) Int. Cl. G06F 3/048

(52) U.S. Cl. 715/769; 715/764

(57) ABSTRACT

Methods, systems, and apparatus, including computer programs encoded on a computer storage medium, for visual linking of elements to model attributes. In one aspect, a method includes receiving a data stream comprising a plurality of element instances wherein an element instance of a first type in the data stream has an attribute with respective data and another element instance of the first type in the data stream does not have the attribute; creating a data model from the data stream in which all element instances of the first type have the attribute; and presenting an interactive representation of the data model including the attribute in a first region of a user interface (UI) and one or more UI elements in a second region of the UI.

### TECHNICAL FIELD

The subject matter of this application is generally related Integrated Development Environments (IDEs).

### BACKGROUND

Integrated Development Environments (IDEs) are designed to maximize software programmer productivity by providing highly integrated graphical user interfaces (GUIs). Typically an IDE is dedicated to a specific programming language, so as to provide a feature set which most closely matches the programming paradigms of the language. However, multiple-language IDEs are in use. IDEs usually present a single software program in which all software development is done that provides many features for authoring, modifying, compiling, deploying and debugging software. For example, programming language code can be compiled while being written, providing instant feedback on syntax errors. This can result in less task switching on the programmer's part than when using discrete development tools. While IDEs can automate some aspects of software development, many rudimentary software programming tasks remain the responsibility of the software developer.

### SUMMARY

In general, one aspect of the subject matter described in this specification can be embodied in a method performed by data processing apparatus, the method comprising: receiving a data stream comprising a plurality of element instances wherein an element instance of a first type in the data stream has an attribute with respective data and another element instance of the first type in the data stream does not have the attribute; creating a data model from the data stream in which all element instances of the first type have the attribute; presenting an interactive representation of the data model including the attribute in a first region of a user interface (UI) and one or more UI elements in a second region of the UI; receiving first input to the UI associating the attribute with a UI element; and generating a program configured to read a first element instance of the first type from the data stream and present the attribute for the first element instance with a run-time version of the associated UI element. Other embodiments of this aspect include corresponding systems, apparatus, and computer program products.

These and other aspects can optionally include one or more of the following features. The data stream can have a format of eXtensible Markup Language (XML) or JavaScript Object Notation (JSON). The program can be further configured to present respective data of the presented attribute. Creating the data model can include sampling a subset of the element instances in the data stream. The program can be further configured to read a second element instance of the first type from the data stream wherein the second element instance lacks the attribute. The program can be further configured to present a default value for the attribute of the second element with the run-time version of the associated UI element. The first input can be a drag-and-drop operation from the first region to the second region.

In general, another aspect of the subject matter described in this specification can be embodied in a system comprising: a computer-readable storage device including a program product; one or more computing devices configured to interact with the storage device and execute the program product to perform operations comprising: analyzing a data stream comprising a plurality of element instances wherein an element instance of a first type in the data stream has an attribute with respective data and another element instance of the first type in the data stream does not have the attribute; determining a model for the data stream based on the analyzing in which all element instances of the first type have the attribute; and reading a first element instance of the first type from the data stream wherein the first element instance lacks the attribute and providing a default value for the attribute. Other embodiments of this aspect include corresponding methods, apparatus, and computer program products.

These and other embodiments can optionally include one or more of the following features. The data stream can have a format of eXtensible Markup Language (XML) or JavaScript Object Notation (JSON). Analyzing the data stream can include sampling a subset of the element instances in the data stream. Analyzing the data stream can include determining a grammar for data in the data stream and analyzing the data stream based on the determined grammar. Reading the first element instance from the data stream can include determining whether the first element instance is of the first type based on the model and further determining whether the first element instance lacks any attribute for the first type of element instance. A UI element associated with the attribute can be determined and the default value is presented using the UI element.

In general, another aspect of the subject matter described in this specification can be embodied in a computer program product, encoded on a computer-readable medium, operable to cause data processing apparatus to perform operations comprising: receiving a data stream comprising a plurality of element instances wherein an element instance of a first type in the data stream has an attribute with respective data and another element instance of the first type in the data stream does not have the attribute; creating a data model from the data stream in which all element instances of the first type have the attribute; associating the attribute with a UI element; and generating a program configured to read a first element instance of the first type from the data stream and present the attribute for the first element instance with a run-time version of the associated UI element. Other embodiments of this aspect include corresponding systems, apparatus, and methods.

These and other embodiments can optionally include one or more of the following features. The data stream can have a format of extensible Markup Language (XML) or JavaScript Object Notation (JSON). The program can be further configured to present respective data of the presented attribute. The data model can include sampling a subset of the element instances in the data stream. The program can be further configured to read a second element instance of the first type from the data stream wherein the second element instance lacks the attribute. The program can be further configured to present a default value for the attribute of the second element with the run-time version of the associated UI element. The first input can be a drag-and-drop operation from the first region to the second region.

Particular embodiments of the subject matter described in this specification can be implemented so as to realize one or more of the following advantages. Data streams having unknown formats can be automatically analyzed to create data models that represent schemas for the data streams. The data models are visualized in an IDE which enables users to recognize and use data in the stream. The IDE automatically analyzes data streams and allows graphical user interface elements to be interactively bound to attributes in data streams. The IDE can generate application programs that are capable of receiving data streams having unknown formats and binding attributes in the data streams to GUI elements.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A illustrates an example interactive GUI for an IDE.

FIG. 1B illustrates an example run-time version of a GUI element.

FIG. 2 is a schematic diagram of an example system.

FIG. 3 is a schematic diagram of another example system.

FIG. 4 illustrates a data stream and a corresponding data model.

FIG. 5 is a flow chart of an example technique for binding GUI elements to attributes of a data model.

Like reference numbers and designations in the various drawings indicate like elements.

### DETAILED DESCRIPTION

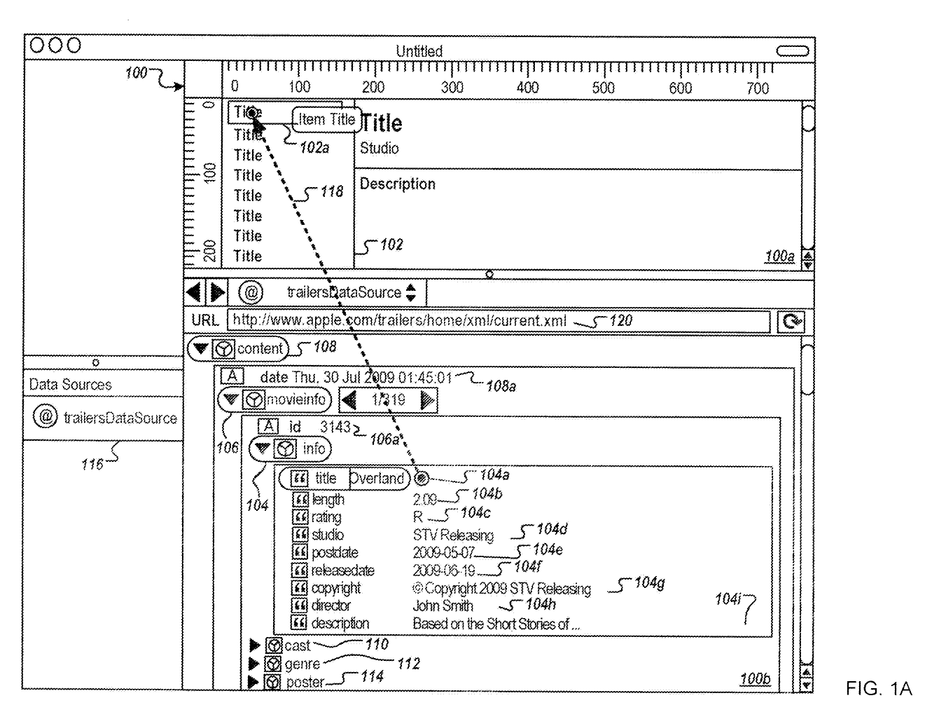

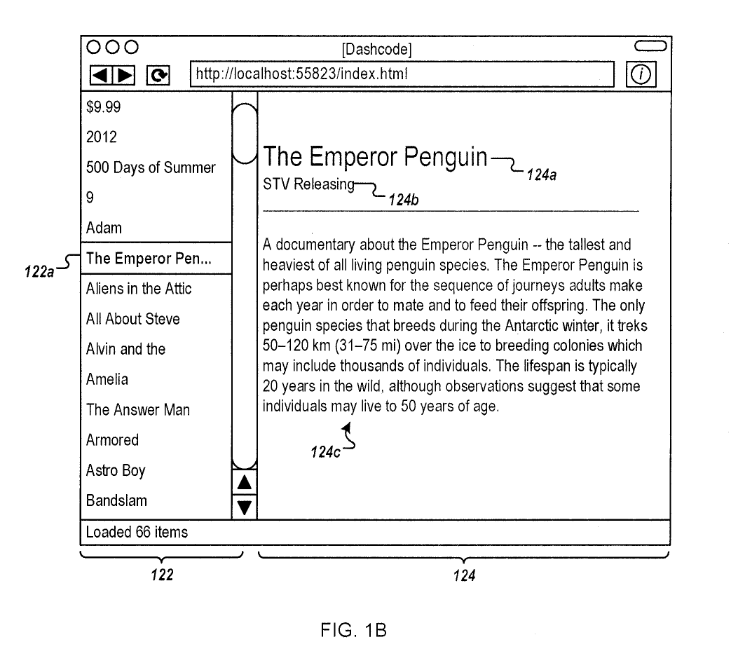

FIG. 1A illustrates an example interactive GUI 100 for an IDE. In some implementations, the GUI 100 can include several regions including a GUI builder region 100a and model view region 100b. The regions 100a and 100b can be included in the same window or can reside in different windows, for example. Moreover, the regions 100a and 100b do not have to be presented simultaneously. The GUI builder region 100a provides an interactive canvas for positioning one or more GUI elements such as collections (e.g., collections 102), lists, buttons, menus, hyperlinks, tags, audio, video, images, text input fields, scrollbars, for instance, and binding the GUI elements to data and application programming logic. The IDE generates a software application having a run-time version of the GUI elements. An example IDE is Dashcode (available from Apple Inc., of Cupertino, Calif.).

The model view region 100b presents a visual representation of a data model that allows users to interactively bind model attribute values to GUI elements (e.g., GUI elements 102a) such that the GUI elements can use, display, and/or modify model values in a run-time version of the GUI element. A data model can include one or more elements wherein each element can have zero or more attributes. Data values can be associated with elements, attributes, or both. In some implementations, elements can be hierarchically related as parent and child. An element that is a child of another element is termed an attribute of that element. In further implementations, an element can have one or more attributes that are not children.

For example, a data model can be based upon the following example data as represented in the following eXtensible Markup Language (XML):

```
<content date=”Thu, 30 Jul 2009 01:45:01”>
  <movieinfo id=”3143”>
      <info>
          <title>$9.99</title>
          <length>2:09</run-time>
          <rating>R</rating>
      </info>
  </movieinfo>
  <movieinfo id=”2927”>
      ...
  </movieinfo>
</content>.
```

The ‘content’ element has a ‘date’ attribute having a value of “Thu, 30 Jul. 2009 01:45:01”. The ‘date’ attribute is not a child of the ‘content’ element. The ‘content’ element also has two ‘movieinfo’ attributes which are themselves elements and are hierarchically children of ‘content’. The first ‘movieinfo’ element has an ‘id’ attribute (which has a value of “3134”) and an ‘info’ attribute which itself has attributes of ‘title’, ‘length’ and ‘rating’. The ‘id’ attribute is not a child of the ‘movieinfo’ element whereas the ‘info’ element is. The attributes ‘title’, ‘length’ and ‘rating’ are themselves elements and children of ‘movieinfo’.

A data model can be derived from a data source that includes one or more electronic files, databases, local (i.e., originating from the same computing device) or remote data streams (i.e., originating from a different computing device), other storage, or processes that are capable of dynamically generating the data source, for instance. A data stream can be a sequence of data that can be uncompressed, compressed, un-encoded, encoded, formatted, or unformatted. Data streams can be retrieved or assembled from one or more memories, files, network connections, or other sources. In some implementations, a GUI element can itself be designated as a data source and the corresponding data model reflects the GUI element's static and/or run-time properties such as, for example, the identification of a currently selected item in the collection 102.

By way of illustration, a data source is indicated in the GUI 100 by icon 116. User selection of the icon 116 causes the data model for the data source to be presented in model view region 100b. The entire data model is shown in region 100b or a portion thereof In some implementations, the view region 100b presents a data model in the form of an interactive tree that reflects the hierarchy of the data model's elements. To view a child element, the tree can be interactively expanded (e.g., by a user selecting a parent element) and to hide a child element, the tree can be interactively collapsed. A user can select the info attribute 104 to expose its attributes 104a-i or hide them, for instance. Other visual representations of data models are possible.

In this example, the data model includes a root content element 108. The content element 108 has a date attribute 108a and a movieinfo attribute 106. The movieinfo attribute 106 is itself an element and has the following attributes: id 106a, info 104, cast 110, genre 112 and poster 114. In this example, the value for the id attribute 106a uniquely identifies a movie. The content element 108 can have many movieinfo attributes 106, each representing information about a movie identified by the id attribute 106a. The info attribute 104 is itself an element having attributes 104a-i which are associated with data that describes the movie identified by the id attribute 106a. A user can select the info attribute 104 to expose its attributes 104a-i or hide them.

GUI elements can be interactively or non-interactively (e.g., programmatically) bound to data model attributes which allows the GUI elements to present and modify data values associated with their attributes. A modification to an attribute's data value by a GUI element can be stored in the data model. Likewise, a modification of an attribute's data value in the data model can cause a GUI element bound to that attribute to update its presentation of the data value to match the data value in the model. In some implementations, users interactively bind a data model attribute to a GUI element using a drag-and-drop mouse or finger gesture illustrated by line 118. Other ways to bind GUI elements to data model attributes are possible, including by way of a software application communicating binding information to the IDE through use of an Application Programming Interface (API).

By way of illustration, a user selects a data model attribute such as title 104a with an input device such as a mouse or a touch screen, for example, and “drags” (e.g., with a mouse or a finger gesture) the title over to the split layout view GUI element 102 and “drops” the title 104 attribute at location 102a which is on the left side of the split layout GUI element 102. This binds a text part inside a list inside the left side of the split layout view GUI element 102 to a path ‘*.info.title’ which is a reference to the hierarchical location of the title attribute in the data model. A run-time version of the split layout view GUI element 102 generated by the IDE will display the value of the title attribute of one or more movies at GUI element 108 in its left view 122 as shown in FIG. 1B in a data stream that is processed according to the data model path. Continuing with the illustration, the studio 104d (‘*.info.studio’) and description 104i (‘*.info.description’) attributes have also been bound to the split layout view GUI element 102. At run-time, user selection of a title (e.g., 122a) in the left view 122 of GUI element 102 will cause the GUI element 102's logic to display the title 124a, the studio 124b and the description 124c attributes for the selected move 122a in the right view 124 of GUI element 102.

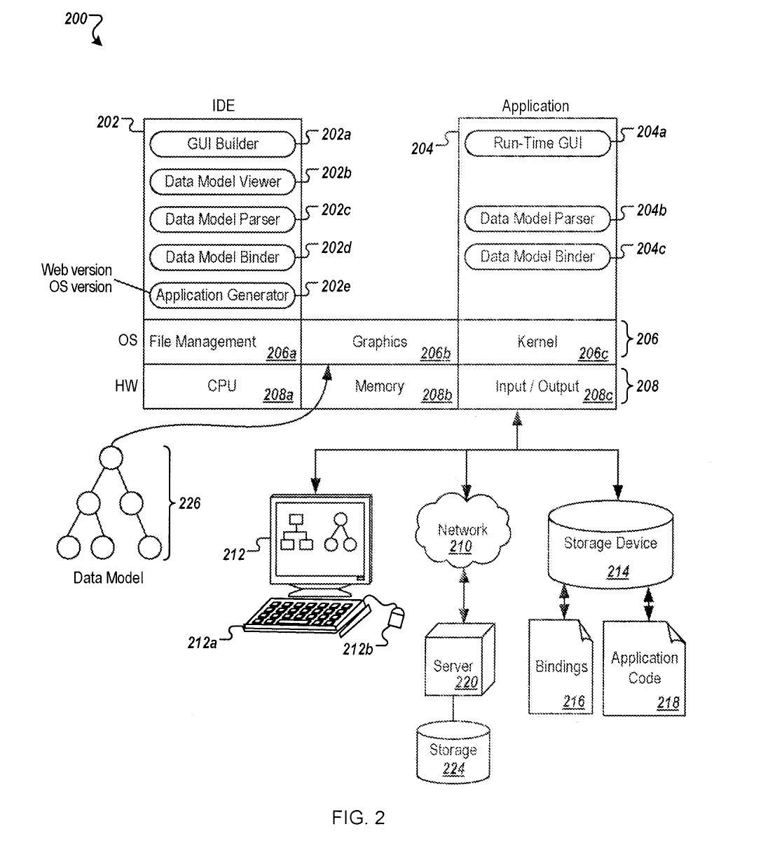

FIG. 2 is a schematic diagram of an example system 200 which can include a data processing apparatus (or “computing device”) 208, a operating system 206, an IDE software application 202 running atop the operating system 206, and an optional software application 204 generated by the IDE 202. Note that the generated application 204 can be executed or interpreted on other systems, even those that do not include the IDE 202. The computing device 208 can be a personal computer, a portable computer, a mobile telephone, an electronic game system, or other device. The computing device 208 can include one or more general purpose and/or specialized central processing units (CPUs) 208a for interpreting data and instructions to perform operations of the IDE 202 and the generated application 204. The computing device 208 also includes memory 208b for storing data and instructions, and one or more input/output device interfaces 208c that allow the computing device 208 to communicate with hardware devices such as displays 212, keyboards 212a, mice 212a, touch-sensitive surfaces, microphones, video cameras, storage devices 214 (e.g., hard disks or other persistent memory) and communication networks 210 (e.g., the Internet), for example.

The operating system 206 is a layer of software that hides underlying details of the computing device 208 from executing software applications such as the IDE 202 and the generated application 204. In various implementations, the operating system kernel 206c coordinates the execution of software applications on the computing device 208 and arbitrates access to the computing device 208's resources such as the memory 208b, the processing time of the CPUs 208a, and system data structures such as those used to facilitate inter-process communication, for instance. The operating system 206 includes file management 206a functionality for maintaining a file system on local (e.g., 214) and/or remote storage (e.g., 224), and provides programmatic access (e.g., via an API) to files and the file system. The graphics component 206b of the operating system provides APIs and functionality that allow software applications to perform graphics operations and to provide a run-time GUI on display device 212 or another device.

The IDE 202 can include logical software components: GUI builder 202a, a data model viewer 202b, a data model parser 202c, a data model binder 202d, and an application generator 202e. These components can reside in the same or different software applications, and can execute on the same or different computing devices. The GUI builder 202a provides a canvas (e.g., 100a) on a display device (e.g., 212) that allows users to interactively create a GUI for an application by arranging GUI elements and configuring their run-time logic. The data model viewer 202b provides a visual representation of a data model 226 and its attributes on a display device (e.g., 212). The data model binder component 202d creates associations between GUI elements and attribute paths in the data model 226 based on user interaction with the GUI. The data model binder 202d also includes an API that allows GUI elements and their run-time counterparts to retrieve and modify attribute values in the data model 226 by specifying data model attribute paths. In some implementations, the associations are stored in a file 216 for use by the application generator 202e. The application generator 202e uses the bindings to generate an application 204 that includes run-time versions of GUI elements that are able to access data model attributes in a data stream.

The data model parser 202c determines the data model for a data stream by analyzing some or all of the data in the stream to determine its grammatical structure with respect to one or more possible formal or informal grammars (or “grammars”). In some implementations, a grammar is a set of formation rules that describe which strings formed from an alphabet of a formal language are syntactically valid within the language. For example, the structure of an XML document and a C++ program conform to the XML grammar and the C++ grammar, respectively. In some implementations, the data model parser 202c first performs token generation, or lexical analysis, of the data stream by splitting data in the stream into symbols defined by a grammar of regular expressions. Other ways of tokenizing the data stream are possible, however.

Next, the data model parser 202c performs syntactic analysis, which can include checking that the tokens form allowable expressions in a grammar, and builds a data structure such as a parse tree, for example, to represent the hierarchical structure data in the input stream. If the tokens do not form allowable expressions in a given grammar (e.g., for XML), a different grammar can be tried (e.g., for JavaScript Object Notation (JSON)). Alternatively, the data model parser 202c can attempt to correct errors (e.g., syntax errors) by adding or removing tokens, for example, to continue parsing the data stream. The data model parser 202c determines the data model 226 for data in the data stream from the parse tree while the parse tree is being constructed or thereafter. The parse tree represents some or all of the data in the data stream, as it may not be necessary to parse all of the data in the data stream to determine the data model 226. In some implementations, determining a data model 226 can include deducing a set of attributes for a data model element based on parsing some or all of the data in the data stream.

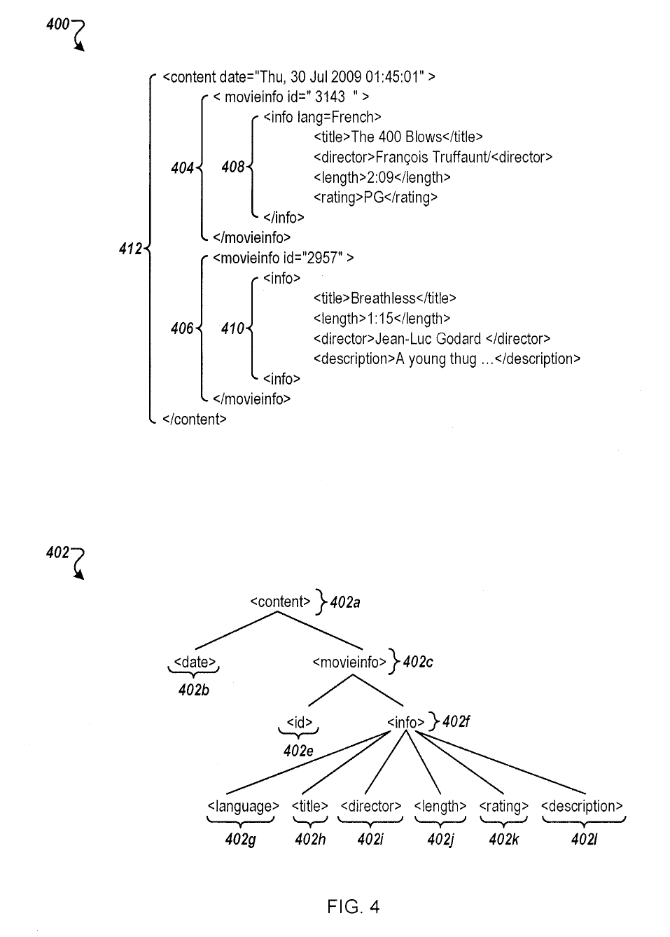

FIG. 4 illustrates an example data stream 400 and a corresponding example data model 402. The data stream 400 can include a top-level ‘content’ element 412 which is represented as node 402a in the data model 402. The data stream 400 includes two instances of the ‘movieinfo’ attribute: 404 and 406. Both ‘movieinfo’ instances have an ‘id’ attribute and an ‘info’ attribute, which are represented in the data model 402 by nodes 402e and 402f, respectively. The first instance of the ‘info’ element 408 in the data stream 400 includes the following attributes: ‘lang’, ‘title’, ‘director’, ‘length’ and ‘rating’. Whereas the second instance of the ‘info’ element 410 includes the following attributes: ‘title’, ‘length’, ‘director’, and ‘description’. In some implementations, when attributes for a given element differ among two or more instances of the element in the data stream 400, data model parser 202c concludes that the element is assumed to have a superset of all attributes encountered for that element in the data model 402. In this example, the ‘info’ element is represented in the data model 402 as node 402f having the following attributes: lang 402g, title 402h, director 402i, length 402j, rating 402k and description 402l. In further implementations, the determination of which attributes to include for an element in the data model 402 can be based on the number of times the attribute occurs in all instances of the element. For example, if the attribute only occurs one time for a thousand instances of an element in a data model, it may be desirable to omit it from the data model 402. Other ways of selecting attributes are possible.

Referring again to FIG. 2, the IDE 202's application generator 202e module generates the computer program 218 for the application 204 based on the GUI element to data model attribute bindings 216. In some implementations, the application generator 202e emits any necessary HTML, Cascading Style Sheets (CSS) and JavaScript to implement GUI elements. The data source bindings are provided in a declarative list of instructions which define how GUI elements interact with data sources at runtime.

In various implementations, the generated application 204 includes logical software components: a run-time version of the GUI elements 204a that were specified and configured through use of the GUI builder 202a, a data model parser component 204b for processing a data stream to determine the data model (e.g., 226, 402) for the data stream, and a data model binder 204c. These components can reside in the same or different software applications, and can execute on the same or different computing devices. The data model binder 204c includes an API that allows run-time GUI elements and other application 204 logic to retrieve and modify attribute values in the data model 226 by specifying attribute paths. The data stream can be retrieved from storage (e.g., memory 208b, disk 214) or from a network server (e.g., server 220), for example. The data model binder 204c uses attribute paths to intelligently read data from the data stream and account for missing attributes. In further implementations, the data model binder 204c API provides default values for attributes of the data model that are missing from an element being read from the data stream. For example, a missing string attribute can be given default value of an empty or null string.

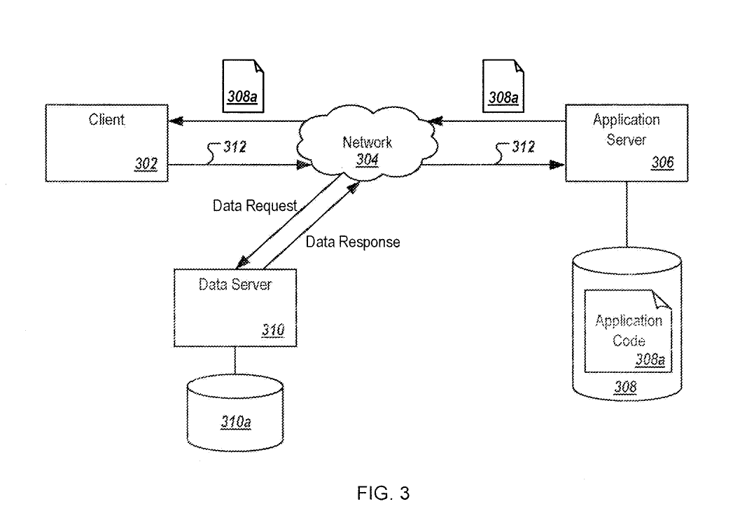

FIG. 3 is a schematic diagram of another example system 300. The system 300 includes a client 302, an application server 306, and a data server 310, all connected by one or more networks 304. The client 302 is a computing device attached to the network 304 and is configured with web browser software or other software having similar functionality. In some implementations, the generated application 204 is in the form of a web page 308a that can include JavaScript or other programming code that implements some or all of the functionality of the generated application 204 as described above. When requested by the client 302 (e.g., through an HTTP request sent by a web browser on the client 302), the application server 306 retrieves the web page 308a from storage 308, or dynamically generates the web page 308a, and sends the web page 308a through the network 304 to the client 302. The client 302 web browser or other application then executes or interprets the programming code of the web page 308a which causes the data model parser 204b to request a data stream from the data server 310. The data server 310 retrieves the requested data from storage 310a or another source and sends the data to the client 302. The data model parser 204b then determines a data model for the data stream after which run-time GUI elements represented in the web page 308a can read and process data from the stream.

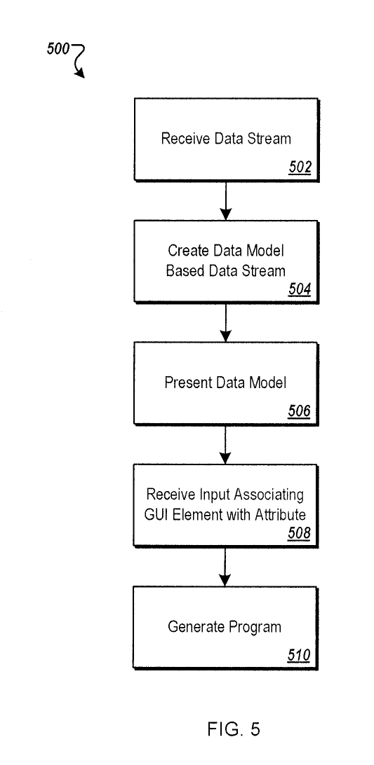

FIG. 5 is a flow chart of an example technique 500 for binding GUI elements to a data model. A data stream is received (e.g., by the data model parser 202c). The data stream includes element instances wherein some of the instances do not have the same attributes as other element instances of the same type (step 502). A data model is created from the data stream (e.g., by the data model parser 202c) in which all elements of a given type have the same attributes (step 504). An interactive representation (e.g., 100b) of the data model (e.g., 226) is presented in a first region of a GUI (e.g., by data model viewer 202b) as well as one or more GUI elements (e.g., by GUI builder 202a) in a second region (e.g., 100a) of the GUI (step 506). User input is received associating an attribute of the data model with a GUI element (e.g., by the data model binder 202d; step 508). An application program is generated (e.g., by the application generator 202e) which is configured to read element instances from the data stream and present the attribute for the first element instance with a run-time version of the associated GUI element (step 510).

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform run-time environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, byway of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving a data stream comprising a plurality of element instances wherein an element instance of a first type in the data stream has an attribute with respective data and another element instance of the first type in the data stream does not have the attribute;
creating a data model from the data stream in which all element instances of the first type have the attribute;
presenting an interactive representation of the data model including the attribute in a first region of a user interface (UI) and one or more UI elements in a second region of the UI;
receiving first input to the UI associating the attribute with a UI element; and
generating a program configured to read a first element instance of the first type from the data stream and present the attribute for the first element instance with a run-time version of the associated UI element.

2. The method of claim 1 wherein the data stream has a format of extensible Markup Language (XML) or JavaScript Object Notation (JSON).

3. The method of claim 1 wherein the program is further configured to present respective data of the presented attribute.

4. The method of claim 1 creating the data model includes sampling a subset of the element instances in the data stream.

5. The method of claim 1 wherein the program is further configured to read a second element instance of the first type from the data stream wherein the second element instance lacks the attribute.

6. The method of claim 5 wherein the program is further configured to present a default value for the attribute of the second element with the run-time version of the associated UI element.

7. The method of claim 1 wherein the first input is a drag-and-drop operation from the first region to the second region.

8. A system comprising:
a computer-readable storage device including a program product;
one or more computing devices configured to interact with the storage device and execute the program product to perform operations comprising:
analyzing a data stream comprising a plurality of element instances wherein an element instance of a first type in the data stream has an attribute with respective data and another element instance of the first type in the data stream does not have the attribute;
determining a model for the data stream based on the analyzing in which all element instances of the first type have the attribute; and
reading a first element instance of the first type from the data stream wherein the first element instance lacks the attribute and providing a default value for the attribute.

9. The system of claim 8 wherein the data stream has a format of eXtensible Markup Language (XML) or JavaScript Object Notation (JSON).

10. The system of claim 8 wherein analyzing the data stream includes sampling a subset of the element instances in the data stream.

11. The system of claim 8 wherein analyzing the data stream includes determining a grammar for data in the data stream and analyzing the data stream based on the determined grammar.

12. The system of claim 8 wherein reading the first element instance from the data stream includes determining whether the first element instance is of the first type based on the model and further determining whether the first element instance lacks any attribute for the first type of element instance.

13. The system of claim 8, further comprising determining a UI element associated with the attribute and presenting the default value using the UI element.

14. A computer program product, encoded on a computer-readable medium, operable to cause data processing apparatus to perform operations comprising:
receiving a data stream comprising a plurality of element instances wherein an element instance of a first type in the data stream has an attribute with respective data and another element instance of the first type in the data stream does not have the attribute;
creating a data model from the data stream in which all element instances of the first type have the attribute;
associating the attribute with a UI element; and
generating a program configured to read a first element instance of the first type from the data stream and present the attribute for the first element instance with a run-time version of the associated UI element.

15. The program product of claim 14 wherein the data stream has a format of extensible Markup Language (XML) or JavaScript Object Notation (JSON).

16. The program product of claim 14 wherein the program is further configured to present respective data of the presented attribute.

17. The program product of claim 14 creating the data model includes sampling a subset of the element instances in the data stream.

18. The program product of claim 14 wherein the program is further configured to read a second element instance of the first type from the data stream wherein the second element instance lacks the attribute.

19. The program product of claim 18 wherein the program is further configured to present a default value for the attribute of the second element with the run-time version of the associated UI element.

20. The program product of claim 14 wherein the first input is a drag-and-drop operation from the first region to the second region.
